(19) United States
(12) Patent Application Publication
(10) Pub. No.: US 2006/0151042 A1
(43) Pub. Date: Jul. 13, 2006

(54) Pipe liner

(76) Inventors: William D. Stringfellow, Houston, TX (US); Kenneth R. Charboneau, Slidell, LA (US); Stephen C. Catha, Houston, TX (US)

Correspondence Address: Guy McClung, PMB 347, 16690 Champion Forest Drive, Spring, TX, 77379-7023, US

(21) Appl. No.: 11/033,962

(22) Filed: Jan. 12, 2005

(51) Int. Cl. F16L 11/00

(52) U.S. Cl. 138/125; 138/98; 138/129

(57) ABSTRACT

A liner for pipe, methods to make liners, and methods for using them, the liner in one aspect including as a first layer a hollow cylinder of polymeric material, a second layer of wrap material around the first layer, a third layer of wrap material wrapped around the second layer, at least one strengthener member on the liner and extending from a first end thereof to a second thereof, and an exterior cover, the liner being a stand-alone structure.

### BACKGROUND OF THE INVENTION

1. Field of the Invention

The present invention in certain aspects, is directed to lined pipe and pipelines, to pipelines with liners and fiber optic sensors, to methods for making them, and, in certain particular aspects, to continuous reinforced thermoplastic pipe liner intended for use as a stand alone pipe liner in the restoration of degraded pipelines.

2. Description of Related Art

Pipeline and/or underground transport of liquids and gases has been utilized for many years. Such pipeline and/or underground transport has proven to be an efficient and safe manner in which to transport potentially explosive, flammable, and/or toxic liquids (e.g. crude oil) and gases (e.g. methane and propane) over long distances. One method for providing such long distance underground transport has been through metal tubes and pipes. In the past, the utilization of metals (such as steel, copper, lead, and the like) was effective from cost and raw material supply perspectives. However, with the population growing throughout the world and the necessity for transporting liquids and gases to more locations increases, the continued utilization of such metal articles has become more and more difficult for a number of reasons. Initially, the production of such metal tubes and pipes is done with high-temperature production methods at specific foundries which are often located a substantial distance from the desired installation site. Such off-site production can require transport of cumbersome metal articles to an installation location and then subsequent placement into already-dug channels. These procedures can be difficult to follow since metal articles are rather heavy and must be connected together to form the desired pipeline. Additionally, in order to reduce the number of connections between individual pipes, longer metal pipes could be formed, which adds to the complexity with an increase in required welded connections. Further problems associated with metal pipes and tubes include the potential for internal and external corrosion (which may contaminate the transported liquid or gas), the low threshold of earth-shifting resistance which could cause a break within the pipeline, and the difficulty in replacing worn out metal pipes in sections, again due to the metal pipe weight, metal pipe length, and connection welds. These problems have proven to be extremely troublesome in certain geographic areas which are is susceptible to earthquakes and tremors on a regular basis. When unexpected earthquakes have occurred in the past, the metal gas and liquid pipelines have not proven to be flexible enough to withstand the shear forces applied thereto and explosions, leaks, or discontinued supplies to such areas have resulted. These metal articles have remained in use because of their ability to withstand high pressures. Furthermore, although such metal pipes are designed to withstand such high pressures (e.g. above 80 bars) once a crack develops within the actual metal pipe structure, it has been found that such cracks easily propagate and spread in size and possibly number upon the application of continued high pressure to the same weakened area. In such an instance, failure of the pipe is therefore imminent unless closure is effectuated and repairs or replacements are undertaken.

Although there is a need to produce new pipelines in various locations around the world, there is also a growing need to replace the now-deteriorating pipelines already in use. Aging pipelines have recently caused concern as to the safety of utilizing such old articles. Unexpected explosions have occurred with tragic consequences. Thorough review and replacement of some old metal pipes is thus necessary. Some of these older pipelines were constructed in what were rural areas but are now heavily populated urban areas, thus increasing the risk associated with a failure. There is a desire to completely replace old pipelines following the same exact routes. In heavily populated areas, the dig and replace method becomes extremely difficult, inconvenient and costly.

Due to the difficulties noted above, there is a need to develop pipeline materials that are safer, longer-lasting, easier-to-install, non-corroding, non-crack propagating, and more flexible. To date, there have been some thermosetting or thermoplastic articles which are designed for such applications. These include certain fiber-wound reinforcement materials (including fiberglass, poly-aramids, polyesters, polyamides, carbon fibers, and the like). However, the resultant articles do not include specific fabric reinforcements (they are fibers wound around specific layers of plastic material) and thus are difficult and rather costly to produce. Furthermore, such fiber-wound materials often cannot be easily produced at the pipe installation site due to the complexity of creating fiber-wound reinforcement articles subsequent to thermoplastic or thermosetting layer production. Additionally, with off-site production, transport and in-ground placement can be a difficult problem. Thus, although some improvements have been provided in the past in relation and in comparison to metal pipes and tubes, there simply is no viable alternative presented to date within the pertinent prior art known to the present inventor which accords the underground liquid and gas transport industry a manner of replacing or restoring such high pressure metal articles.

Pipe liners have been used in a variety of applications to stop further degradation of a pipeline due to internal corrosion, to provide improved resistance to abrasion, and to stop leakage at joints. Pipe liners are generally designed to resist only installation loadings and to serve as a pressure barrier for transported fluids. Operating loadings are transferred directly to the wall of, and resisted by, a host pipe that may have already exceeded its design life. Pipe liners typically do not restore the operating parameters of a pipeline. Pipe liners come in a variety of known forms. These include cured-in-place pipes (“CIPP”). The CIPP product is a fiber reinforcement that is impregnated with an un-cured thermosetting resin that is used primarily in sewer and watermain rehabilitation. The CIPP is inserted into the host pipeline and expanded into contact with the host pipe walls and then cured, often by pumping heated water through the CIPP which is reinforced by the pipeline. CIPP liners are designed to resist only the installation forces and typically do not contribute, or add significantly to, to the strength of the host pipeline. Further they generally do not provide protection against external corrosion. Examples of this type of pipe-liner are disclosed in U.S. Pat. Nos. 4,064,211 and 6,708,729 (and in prior art cited therein). The use of such pipe liners is well documented in the industry literature and is not applicable to the high-pressure applications.

Another type of prior art pipe liner is the extruded thermoplastic pipe-liner. These products are continuous lengths of thermoplastic material such as HDPE (high density polyethylene), nylon, PVC (polyvinylchloride) alloys, and other such materials commonly used for piping applications and/or corrosion mitigation. These materials are sometimes used in combination, that is, multiple layers of different materials, or with discrete length fiber reinforcement, to obtain improved properties. Limitations of this type of product are that it relies on the strength of a host pipeline to resist operating stresses; it has limited tensile strength and can therefore be pulled into a host pipeline only in relatively short lengths, usually one mile or less; and it cannot provide protection against external corrosion. A further limitation of this type of product is the ability of fluids to permeate through the wall. All thermoplastics are permeable to some degree. Gases that permeate tend to be collected in a space at the pipe liner host-pipe interface where pressure can increase to a level approaching the operating pressure of the pipeline. When the pipeline pressure is suddenly reduced, the entrapped gas follows the normal gas laws and expands. Such expansion, often results in a buckling of the pipe liner called “liner collapse”. As a result, pipelines with polymer pipe liners are normally equipped with “venting systems” and operational procedures are established to “vent” permeated fluids (see, e.g. U.S. Pat. No. 5,072,622 which describes a method for removal of such gases before they are able to collapse a pipe liner). Methods developed to install thermoplastic pipe liners include swage-lining, the use of sized rollers and liner tension to reduce the pipe liner diameter (see, e.g. U.S. Pat. No. 6,240,612), and the “fold and form” method in which the round liner is folded into a “C,” “H,” “W,” “U” or other shape for insertion (see, e.g. U.S. Pat. Nos. 4,863,365; 4,985,196; 4,998,871 and 6,058,978). Applications involving the use of such pipe liners are well documented in the industry literature.

Another well-known pipe liner product and method for rehabilitation of pipelines is the flexible yet rigid spoolable composite pipe member which can be pulled or otherwise inserted into a host pipe. The spoolable composite pipe is of significantly smaller diameter than the host pipe to allow it to be installed. This pipe and method of installation can provide increased pipeline pressure rating and increased internal and external corrosion resistance, but can result in a significant reduction in the effective inside diameter of the host pipe. This results in an increase in pipeline operating costs. An additional significant limitation of this product is the difficulty of road transport of rigid spoolable pipe sizes greater than about four inches in diameter in sufficient continuous length to be cost effective (see, e.g. U.S. Pat. Nos. 3,769,127; 4,053,343, 5,755,266; 5,828,003 and 6,065,540).

Another well-known documented pipe liner product and method for the rehabilitation of pipelines is reinforced thermoplastic pipe which can be inserted or otherwise pulled into a host pipe. This product typically consists of an extruded thermoplastic liner that is reinforced by fiber or tapes which are protected by a cover. This relatively flexible, yet rigid, pipe and method can provide increased pipeline pressure rating and increased internal and external corrosion resistance, but can result in a significant reduction in the effective inside diameter of the host pipe, and in increased pipeline operating costs. Another limitation of this method is the difficulty of road transport of rigid pipe sizes greater than about four inches in diameter in sufficient continuous length to be cost effective (see, e.g. U.S. Pat. Nos. 2,502,638; 4,000,759; 4,384,595; 5,072,622; and 6,305,423).

### SUMMARY OF THE PRESENT INVENTION

The present invention, in at least certain embodiments, discloses pipe liners, methods to make them, methods to install them, and lined pipe or pipelines with a multi-component liner and, in one aspect, a fiber optic sensor system and/or a communications system, e.g. a fiber optic communications system. Certain pipe liners produced in accordance with certain embodiments of the present invention are a stand-alone structure which is capable of withstanding operating and installation loadings and, optionally, with embedded measurement and redundant sensing devices for monitoring the integrity of a restored pipeline on a continuous basis. The present invention also discloses lined pipe and pipelines with the capability for communications/control through a communication system, e.g. a fiber optic communication system with fiber optic cables and/or apparatus, in one aspect with collection and removal apparatus of any permeated fluids. In certain particular aspects, the present invention discloses pipelines (e.g. relatively large diameter degraded pipelines) which are restored to original or near-original specification without digging and without replacement.

The present invention discloses, in at least certain aspects, a light-weight high-strength yet flexible multi-component pipe liner structure that can be installed as a stand-alone pipe liner restoring a pipe or a host pipeline to (or near) its original performance parameters and original service life, while providing increased internal and external corrosion protection and increased protection from damage, e.g. during earthquakes, accidents, and acts of terrorism. In certain aspects, a “stand-alone” pipe liner as used herein is a pipe liner that withstands all (or substantially all) installation and operational loads without assistance.

The present invention discloses, in at least certain aspects, a liner with sufficient axial strength to allow for the lining of existing pipelines with lengths in excess of several miles (e.g. in excess of five miles or in excess of ten miles), in one aspect with single pull installation.

The present invention discloses, in at least certain aspects, apparatus and structure within a pipe or pipeline for collecting and handling permeated fluids, especially gases, that might otherwise cause the pressure barrier to collapse when pipeline pressure is reduced (and, in some cases, suddenly reduced).

The present invention discloses, in at least certain aspects, a method for continuous measuring and monitoring of the integrity of a pipeline.

The present invention discloses, in at least certain aspects, apparatus and systems for the remote operation of pipeline apparatuses, pipeline control devices, and control valves.

In certain aspects, the present invention discloses a stand-alone reinforced thermoplastic pipe liner of continuous length with: a layer of polymeric material; two or more layers of fabric reinforcement material; an axial strengthener [e.g. axial tapes (in one aspect, fiber tapes) or socks, or flattened tubes, e.g., in certain aspects, made from carbon fiber based material, or any suitable high strength fiber or material disclosed herein] for pulling and increasing strength; orbitally wound fibers to lock the tapes in relationship to the fabric reinforcement; optionally, one or a series of fiber optic cables; and, optionally such cables covered by a protective layer, e.g. a protective polymer layer, which, in certain aspects mitigates installation damage and provides structure for collecting and removing permeated fluids. In certain aspects a pipe liner according to the present invention is designed for long term service (fifty years or more) at maximum allowable operating pressures up to 2,000 psi (136 bar) with safety factors in the range from 2.8 to 3.8 against Short Term Burst.

In one particular aspect a first layer of a pipe liner according to the present invention is a first polymeric layer which is an extruded cylindrical thermoplastic or modified thermosetting resin material, such as polyolefin, polyamides, polyvinyl chlorides and alloys thereof, HDPE and polymeric materials that have sufficient resistance to chemical attack and strength to be used in applications involving the transport of hydrocarbons and water. Such materials are readily available worldwide and have had extensive usage in the transportation of natural gas, hydrocarbons and water. An extruded cylinder is produced in long, yet transportable, lengths for ease of inspection and transport to the fabrication site. These discrete length cylinders of polymeric material are welded together, e.g. butt fusion welded, to form a continuous-length inner pressure barrier for the pipe-liner. The weld is accomplished using existing technology in conjunction with, preferably, rapid cooling techniques, to increase the process speed. Both the external and internal weld beads are, optionally, removed during the process and each weld is subjected to a 100% volummetric non-destructive integrity test.

Application of internal pressures to the non-reinforced cylinder results in an expansion of the diameter thereby thinning the wall thickness to the point of breaking, or the pressure is discontinued. Extruded thermoplastic pipe liners used in the past have relied upon the wall thickness of the host pipe to restrict expansion and support the applied pressure without damaging the pipe liner. Development of reinforced plastic pipe has shown that reinforcement applied over the extruded liner allows the pipe to resist higher pressures. In certain aspects of a liner according to the present invention, the first polymeric layer has a ratio of cylinder outside diameter to wall thickness, sometimes referred to as the Standard Dimensional Ratio (“SDR”), within the range from 26 to 36. This ratio allows handling of the cylinder without buckling while enhancing the desired flexibility of the pipe liner.

Reinforcement added to the first layer cylinder of the pipe liner is two or at least two layers of fabric (preferably, but not necessarily, unidirectional fabric) applied under tension and, in one aspect, at essentially equal but opposite angles (that is, plus and minus the same angle, with respect to the pipe liner axis). In certain aspects, each layer of reinforcement of the pipe liner is a single width of fabric. Each width of fabric can have several individual thicknesses of reinforcement material. In certain aspects the material used is one of several advanced reinforcement fiber materials commonly referred to as “ballistic materials” or “extended chain polyethylene ballistic material”. This material is light weight, exhibits high specific strength, high specific stiffness, low elongation or stretch, and is similar, in some aspects, to the inner liner material.

In certain aspects, the width of the fabric is determined by the relationship:
Coverage=width/(π)(Outside Diameter)(cosine φ)

(where φ is the fabric winding angle)

For example, in one particular case:
Coverage=width/πD Cos φ

For 100% coverage: Coverage−1.00 and Cos φ=width/πD e.g. for a pipe liner with
D=4.500 inches and
Width=8.00 inches,

then Cos φ=8/(3.1416)(4.500)=0.5659 and φ=55.53°

For certain aspects of the present invention, the desired coverage is 100 percent and the nominal value of φ ranges between 50 and 60 degrees, e.g., in one aspect, 54.7 degrees. The outside diameter of the pipe liner increases with each reinforcement layer resulting in a required increase in the fabric width for each layer. For certain aspects of the present invention, the angle φ may be adjusted slightly to produce 100 percent coverage using a single fabric width. In one aspect a thin polyolefin liner (e.g. a layer 10 as described below) resists pressure until the reinforcement becomes loaded and the further increase in pressure is transferred to the reinforcement. This transfer in loading appears to take place at approximately one third of the maximum allowable operating pressure.

Because the materials of construction may have extremely low coefficients of friction, the first reinforcement layer is, optionally, locally bonded to the inner liner and the reinforcement layer(s) are bonded to each other, e.g. using any suitable adhesive, e.g. a glue or rapidly curing adhesive and/or tape. Bonding takes place at one, two, three, four or more independent narrow axial strips (or intermittent amounts of glue or adhesive) equally spaced on the circumference of the substrate. In certain aspects the total width of the axial strips makes up no more than 10% of the circumference of the inner liner (first layer cylinder). The limited bonding is used to maintain the flexibility of the pipe-liner while holding the reinforcements in place during subsequent manufacturing operations and installation.

To permit long lengths of the inventive pipe liner to be installed using a single pull, in certain aspects, one or a plurality, e.g. between 2 and 8 tapes, socks, or tubes (e.g. carbon fiber tape) are spaced around and on top of the fabric reinforcement and bonded to the surface, e.g. using a rapidly curing adhesive. A second set or layer (and in one aspect a third) of tapes may, optionally, be installed on top of the first. The actual number of tapes will vary depending upon the pipe liner diameter and desired tensile strength. In certain aspects, the tape used is a near 100% unidirectional fiber tape produced from high-modulus high-strength carbon fibers. In certain aspects relatively stiff fiber tape is used with a matrix material (e.g. epoxy or similar material). In certain aspects no matrix or filler material is used and the tapes are soft and flexible. In certain aspects, fiber bundles or tows range from 12,000 to 50,000 filaments and multiple tows are used. The fibers may be stitched together. Each of the pulling tapes is laid on the pipe, e.g. in a substantially axial or zero degree position with respect to the axis of the pipe liner. In certain aspects, the actual angle with is respect to the axis will be in the range from 0 to 10 degrees. In one aspect, the pulling tapes are configured and located so that, when a completed liner is folded, e.g. into a “C” shape, for insertion into a pipe, the pulling tapes help maintain the liner in the “C” shape during such insertion.

In one embodiment, with the tapes installed, high strength ballistic material fiber tows are orbitally wound on top of the tapes to secure them in place. This over-wrapping need not provide 100% coverage. In certain aspects, the angle of the tows is ±54.7° nominally and in the range of 50° to 60°. Fiber tows are used to help fix the fiber tapes' relationship with the reinforcement and ensure that the low coefficient of the ballistic fiber fabric and tape will not permit relative movement between the two. Fixing the relationship between the reinforcement fabric and the carbon fiber tapes (or socks or tubes) insures that both materials strain at the same or substantially the same rate, provides additional tensile strength for pulling, and allows greater hoop loading of the fabric.

With the reinforcement in place, components of a continuous measuring, monitoring and communications systems are, optionally, bonded to the pipe surface. This system is intended, in certain aspects, to allow monitoring on a continuous or intermittent basis as determined by the pipeline operator. The system is a fiber optics system. In certain aspects this system is attached to the pipe as a continuous thermoplastic tape, with each tape including two fiber optic cables (one for temperature, one for strain) or four fiber optic cables (two plus two additional cables for redundancy). One half of the fiber optic cables are further enclosed within a tubular void space into which the cables are placed. The other half is embedded within the thermoplastic material. The monitoring system, in one aspect, has a minimum of one such tape and, in one aspect, has at least two such tapes located at 90° to each other and placed on the pipe axially and/or helically. The fiber optic cables enclosed within the tube are designed to allow distributed temperature measurement over great distances. Only one fiber optic cable is required for temperature measurement, the other(s) are redundant and can be used to replace a damaged cable if and when necessary. In one aspect, the fiber optic sensors will respond to localized changes in temperature with an accuracy of about 4° F. and locate the position of the temperature anomaly within about six feet. Changes in temperature reflect a leak or impending leak. The half of the fiber optic sensor(s) embedded within the thermoplastic tape is used to measure localized strains along the length of the pipe. Again, only a single fiber optic cable is required for this measurement, the others are provided for redundancy. The strain sensor, in one aspect, is embedded in the tape which is anchored to the pipe liner wall. Changes in strain level of the pipe liner are measured to an accuracy of about 20 micro-strain (με) and the position of the anomaly is located within a small range, e.g. within about six feet. The data from this sensor, correlated with long term test data (e.g. from regression analysis, e.g. from an ASTM D 2992 test, allows a determination of the integrity of the pipe liner on a continuous basis and further allows corrective action to be taken before a failure or incident occurs.

In addition to the monitoring system, additional fiber optic cables can be provided, according to the present invention, for use in a communications and control system. These fiber optic cables can be included within the tapes mentioned or within separate tapes. Such a system with these fiber optic cables provides a communications and control function to be used to interface with a control/monitor system, remote or on-site, e.g. a pipeline supervisory control and data acquisition (“SCADA”) system and to operate pipeline devices and controllers. Pipeline valves, external to a pipe liner according to the present invention, can be controlled using these cables. In one aspect, the sensors and communications lines are integrated through an existing operating system to provide for control, indications of potential problems, automatic alarms and/or shut down of the pipeline or of apparatuses thereon.

The monitoring system package and reinforcement is, optionally, protected by a polymeric cover or jacket that, in one aspect, is formed from a sheet of material whose width is approximately the same as the circumference of a reinforced pipe liner made, e.g. of polyolefin, nylon, polyvinyl chloride (PVC), high density polyethylene and the like. The sheet, in one aspect, is rolled to form a continuous cylinder that fits tightly around the pipe and is welded to itself to prevent incursion of external debris and or fluids. The cover is on top of the fiber optic packages to protect them from wear and handling damage during folding and pulling into the host pipe. Alternatively a cover is made by coating the structure with a layer of plastic or similar material, e.g., but not limited to, polyurethane, e.g. polyurethane S-355 from IR Products. Such material may be sprayed on or painted on.

This placement results in an annular space between the pipe reinforcement and the inside of the cover sheet due to the presence therebetween of the fiber optic sensors. Spacers are, optionally, placed between the sensor tapes as necessary to support the cover (e.g., separate spacers made of plastic, wood, extruded thermoplastic or thermosetting material or spacers that are integral to a cover). Additionally, in certain aspects, these spacers are, optionally, shaped to permit the accumulation of permeated fluids from the flowing fluid to be vacuumed at an external vent port so there is no accumulation of pressure that might result in damage to the pipe liner. Monitoring the amount of fluid removed and/or pressure relieved provides an additional indication of the integrity of the pipe liner.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or equivalent embodiments.

FIG. 1 is a cross-section view of a liner according to the present invention.

FIGS. 2-5 are side views of components of the liner of FIG. 1.

FIGS. 6-9 and 12, and 14 are cross-sections views of components of a liner as in FIG. 5.

FIG. 10 is a cross-section view of a prior art fiber optic cable.

FIGS. 11A and 11B are schematic drawings of systems used with liners according to the present invention.

FIG. 13 shows shapes for spacers according to the present invention.

FIG. 15 is a schematic view of a method for producing a liner according to the present invention.

### DESCRIPTION OF EMBODIMENTS PREFERRED AT THE TIME OF FILING FOR THIS PATENT

A pipe liner 12 according to the present invention as shown in FIG. 1 has an innermost first layer 10 (which when formed is a hollow cylinder, in one aspect, a deformable/re-formable cylinder), a second layer 20, a third layer 30, fiber strands 40, spacers 50, fiber optic cables 60, and a cover 70.

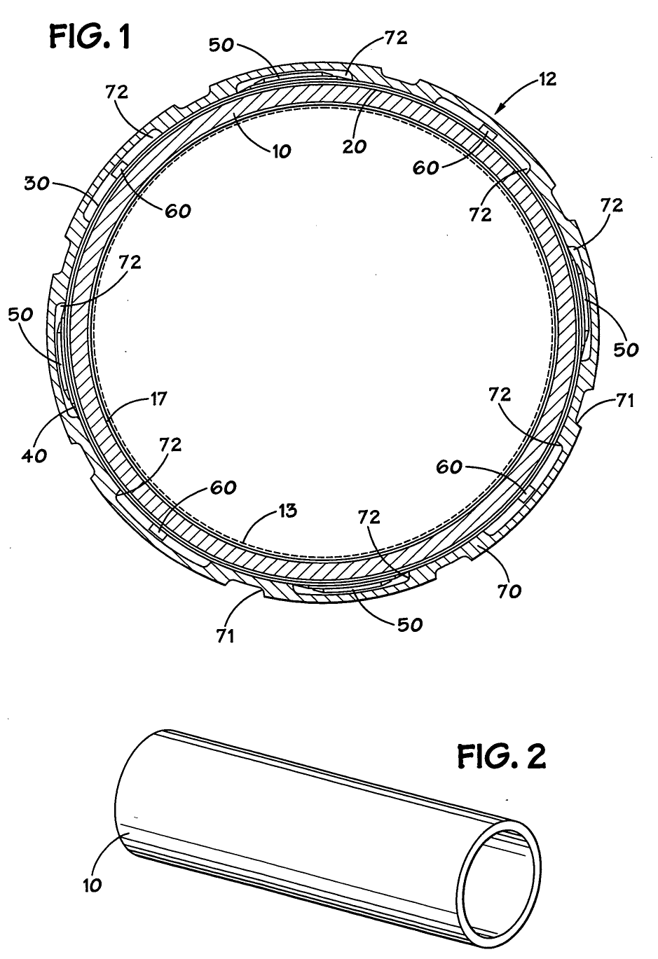

As shown in FIGS. 1 and 2, the first layer 10 is a generally cylindrical member made of flexible material sufficiently strong to support the other layers and components and sufficiently flexible to be compressed, deformed, and re-formed. In one particular aspect the first layer 10 is extruded HDPE (e.g. any suitable grade; e.g. PE 3408, PE 100), with an outside-diameter-to wall-thickness ratio SDR of about 32.5 in hollow cylindrical form. In certain aspects the lined pipe is between 4″ and 30″ in O.D. and, in other aspects, the pipe that is lined is standard size (iron pipe size or IPS) and has an O.D. between 6⅝″ and 16″. In one particular aspect, fifty foot lengths of such first layers are commercially available. In certain aspects a fluid-resistant thermoplastic material is used for the first layer that resists fluids being transported through a pipeline or pipe. NYLON 6 (Trademark) material, RILSAN (Trademark) material, or NYLON 11 (Trademark) material or other suitable thermoplastic material may be used for the first layer.

In certain embodiments, lengths of the first layer 10 are welded together on-site at a location at which the liner 12 is to be installed within a pipe or pipeline. In one aspect the lengths of the first layer 10 are butt fusion welded and while the welds are still hot weld beads are smoothed out and/or removed both inside and outside the layer 10. Optionally, the welded area is tested on-site for integrity, e.g., but not limited to, with known ultrasonic testing apparatus.

As shown in FIGS. 1 and 3, the first layer 10 is wrapped with the second layer 20 which is a layer of material for strengthening the liner 12. Suitable materials for the second layer 20 include fabric with highly oriented HMPE fibers (“HMPE”: high molecular weight polyethylene); SPECTRA (Trademark) material; KEVLAR (Trademark) material; ARAMID (Trademark) material; VECTRAN (Trademark) material; liquid crystal polymer (“LCP”) material; DYNEEMA (Trademark) material; TWARON (Trademark) material; TECHNORA (Trademark) material; fiber-reinforcing material, e.g. carbon fibers, fiberglass fibers and/or hybrid fibers; fabric made from carbon fibers and/or glass fibers; and fabric made from carbon fibers and SPECTRA (Trademark) fibers. In certain particular aspects, SPECTRA (Trademark) material, commercially available from Honeywell Company is used because it has a weight-to-volume ratio of 0.035 lbs/in³. In certain particular aspects, commercially available para-aramid material is used which has a weight-to-volume ratio of 0.051 lbs/in³. In certain particular aspects, commercially available carbon-fiber reinforced material is used which has a weight-to-volume ratio of 0.051 lbs/in³. The thickness of layers 20 and 30, in certain aspects, ranges between 0.010 and 0.240 inches and in one particular aspect is 0.024 inches. In one aspect the layer 20 and/or the layer 30 are highly oriented high molecular weight polyethylene (“HMWPE”).

The second layer 20 is wrapped around the first layer 10, in certain aspects at a wrap angle (or wind angle) between 45 degrees and 70 degrees. In other aspects this wrap angle is between 50 degrees and 60 degrees and, in one particular aspect, this angle is 54.7 degrees. As shown in FIG. 3, the wind angle is designated “plus” to indicate its orientation with respect to a longitudinal axis A of the layer 10 and the wind angle is 56 degrees. Edges of each wrap are butted up against edges of adjacent wraps so no part of the second layer overlaps itself (see, e.g. butting up indicated by arrow W, FIG. 3). Alternatively, a minimal overlap is used; or there is a gap G as shown in FIG. 3. Each wrap of the layer 20 has a width H). Optionally, one, two, three, four, five, six, seven, eight or more tapes, strips, or lines of adhesive or glue 21 are applied on the liner 10. It is to be understood that the entire layer 20 can, according to the present invention, be wrapped around the layer 10 with no gap between wrap edges; with an overlap of some edges; with a gap between all adjacent wrap edges; or with a combination of gap between some edges, overlap of some edges, and/or no gap between others. In certain aspects in which the layer 20 (and/or the layer 30 discussed below) have unidirectional (oriented at the same angle or in the same direction) fibers, the layer 20 is applied so that the fibers are oriented generally at an angle to the longitudinal axis A, in one aspect, at the same angle as the wind angle. By employing no such overlap, overall effective diameter of the liner 12 is reduced. Alternatively, the second layer 20 is wrapped with space between adjacent wrap edges, rather than butting edges against each other which also results in no overlap. In some such aspects, space between adjacent wrap edges is no more than 3% of the total liner surface area.

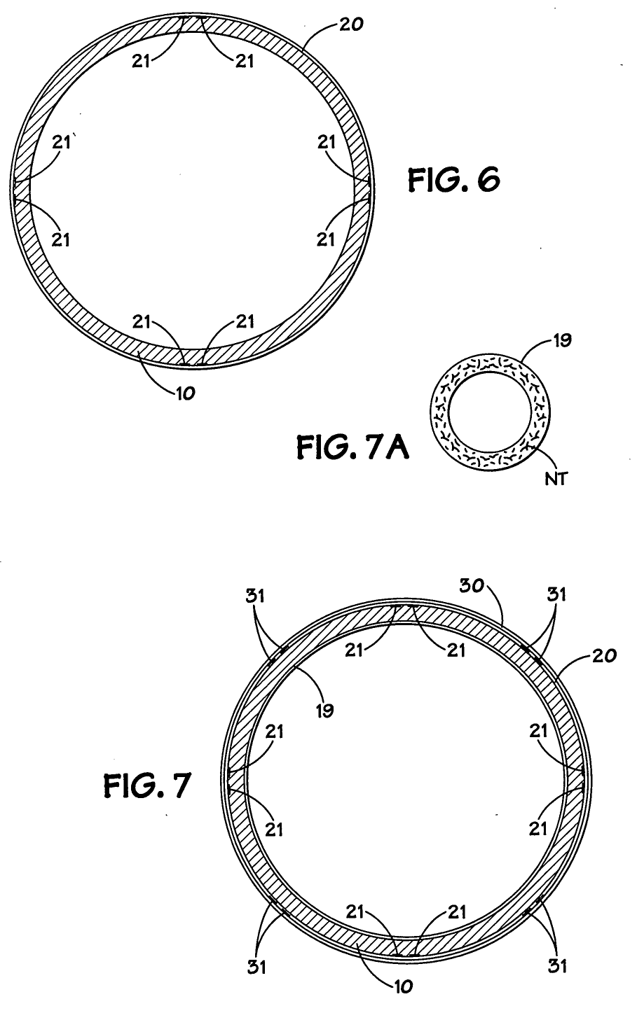

Optionally, as shown in FIGS. 3 and 6, one or more lines or strips of glue, adhesive, or tape 21 may be applied to the first layer 10, either intermittently or from one end of the first layer 10 to the other, either in straight lines (as shown) or wrapped around the first layer 10, to inhibit or prevent slippage of the second layer 20 on the first layer 10. In an embodiment in which SPECTRA (Trademark) fiber material is used with axial carbon fibers, these lines 21 tie the axial carbon fibers to the SPECTRA (Trademark) fibers so the two function at the same strain rate which allows the carbon fibers to strengthen the fabric. In certain aspects a commercially available modified cyanoacrylate type of glue is used, from Loctite Company for the lines 21. As shown in FIG. 6, eight lines 21 are used; but any desired number (e.g. 1, 2, 3, 5, 10, etc.) may be used. In one aspect the lines 21 are sprayed on. In certain aspects the lines 21 (and 31) are applied so that the liner 12 is still sufficiently flexible that it can be deformed and re-formed as desired. In one aspect two, three, four, five or more pairs of two lines are used spaced apart around the circumference.

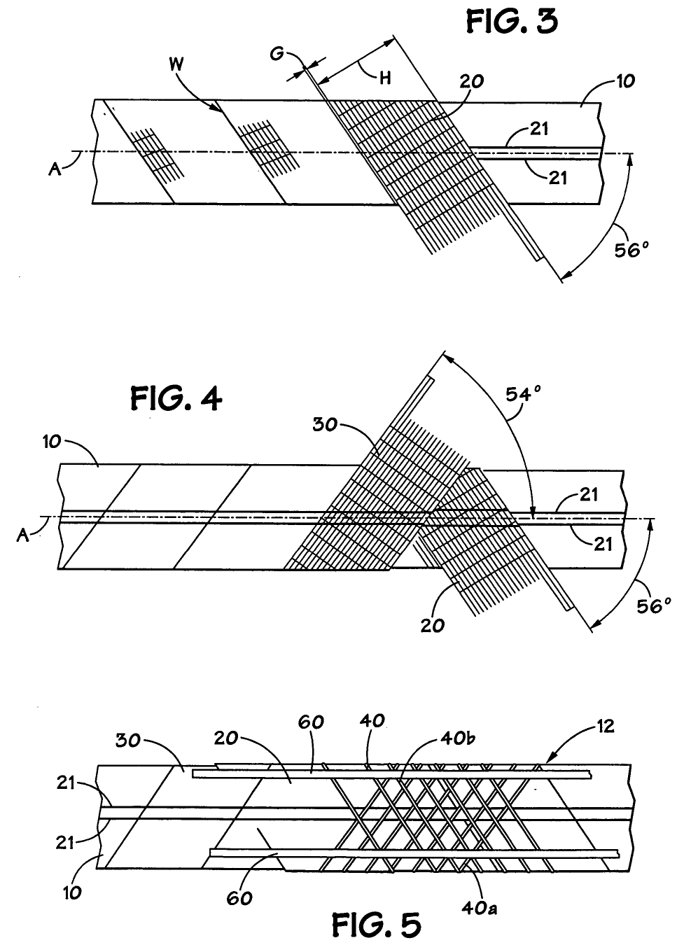

As shown in FIGS. 1, 4 and 7 the third layer 30 is wrapped over the second layer 20 and may be wrapped in any of the ways described for the second layer 20 and may be material as described for the second layer 20, with or without lines, etc. 21 on the layer 20 as described for the layer 10. In one aspect both the second layer 20 and the third layer 30 are SPECTRA (Trademark) material about 0.024 inches thick. In certain aspects the third layer 30, as shown in FIG. 4, is wrapped at a wrap angle opposite to that of the second layer 20 (designated “minus” to illustrate its orientation with respect to the axis A and in a direction opposite to that of the layer 20; and, as shown at a wind or wrap angle of minus 54 degrees). Also, as shown in FIG. 7 (not to scale) in an end view, lines 31 (like the lines 21) may be used between the second layer 20 and the third layer 30.

As shown in FIGS. 1, 5 and 8 one, two, three, four, five twenty, thirty, thirty six, forty or more fiber strands (or “tows”) 40 are used, e.g. wound on the third layer 30 (and/or on the layer 20 and/or on the tapes 50) to strengthen the liner 12 and to facilitate its integrity while it is being pulled into a pipeline. Any suitable fiber may be used. It is within the scope of the present invention to apply strands or tows 40 at different wind angles on a liner 12. Strands 40a are at a plus wind angle and strands 40b are at a negative wind angle.

In certain particular aspects the strands 40 are commercially available fiber tows, which are wound on the liner 12. With the fibers 40 glued or otherwise adhered in place, the fibers 40 and the remaining components form a single integral body which can react to and withstand strain so that creep (undesired movement) of the third layer 30 is reduced and axial loads on the liner 12 are partially absorbed by the tapes 50 thereby reducing strain on the other layers.

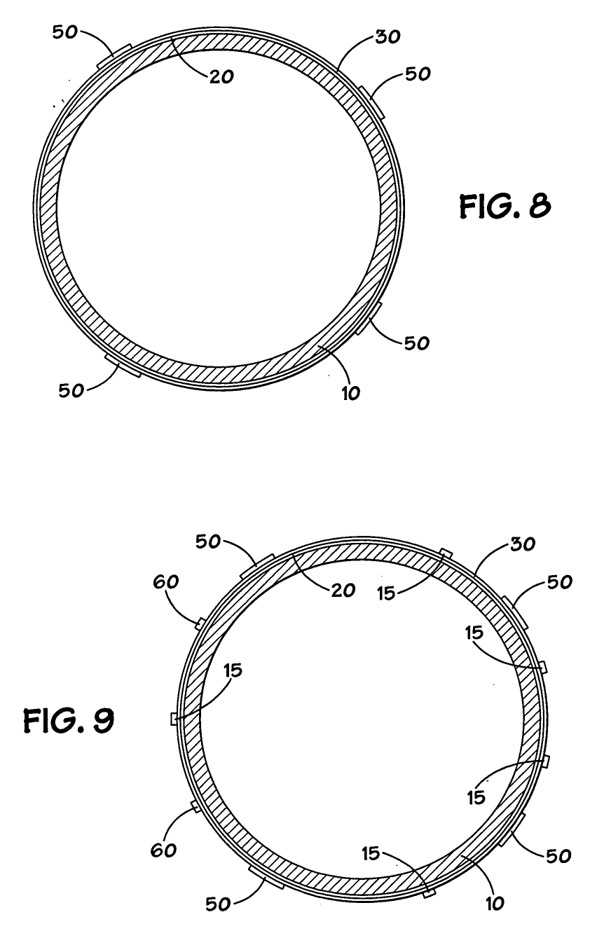

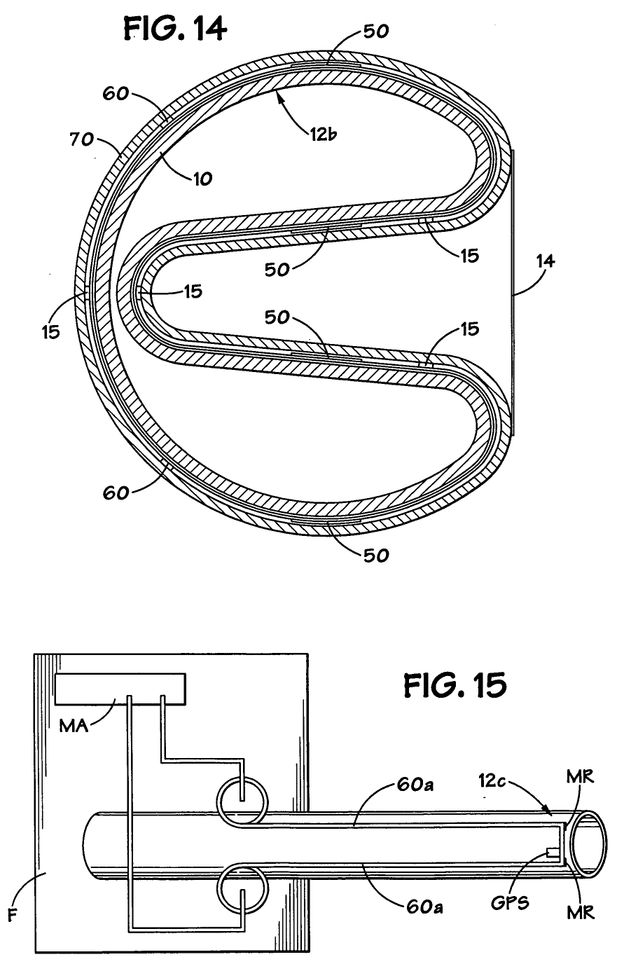

Optionally, as shown in FIGS. 1, 5 and 8, tapes 50 (or socks or tubes) (or stacks of two, three or more tapes 50) may be applied to the third layer 30. Optionally, one or some strands 40 are applied over the layer 20, over the layer 30, and/or over the tapes 50. The strands 40 when used over the tapes 50 tie the tapes 50 to the lower layers. In one particular aspect a first tape or first tapes 50 are applied on the layer 30 then a layer of strands 40 (described below) ties the tapes 50 in place. Then one or more additional tapes 50 is applied over the strands 40 and additional (one or more) strands 40 tie the additional tapes 50 in place. These tapes 56 also enhance the ability of the liner 12 to be pulled into a pipeline. In one particular aspect the tape 50 is carbon fiber tape, about 1.50 inches wide, about 0.040 inches thick, and eight such tapes 50 are used equally spaced around the circumference of the liner and extending in straight lines from one end thereof to the other (or 4 pairs of 2 tapes stacked one on the other are used). The tapes 50 (and the fibers 40) can be equally spaced around the liner circumference or not; e.g. FIGS. 8 and 9 show a cross-section view with particular spacing for the tapes 50. The spacing for the tapes 50 as shown in FIG. 9 facilitates the maintenance of a folded liner 12 (insertable into a pipe or pipe line) in a general “C” shape as described below (see FIG. 14).

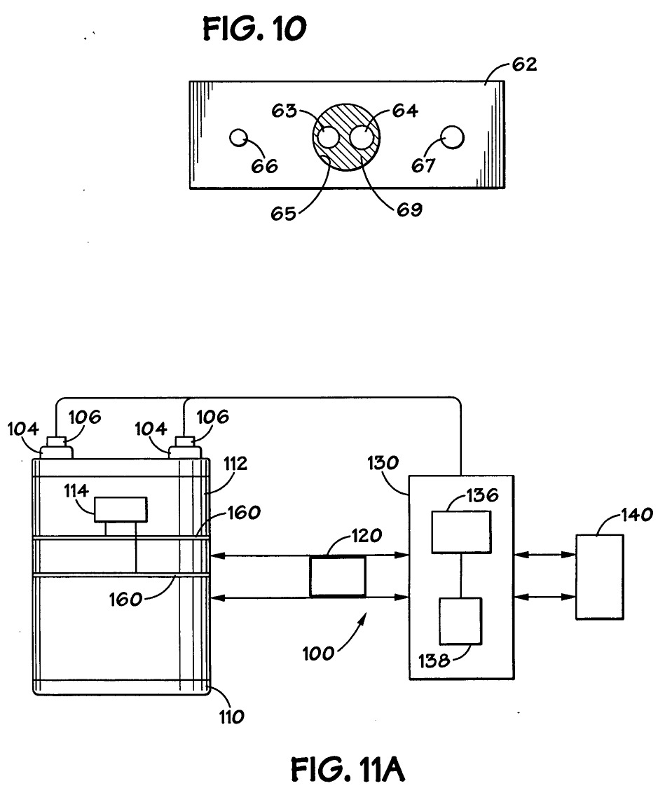

As shown in FIGS. 1 and 9, fiber optic cables 60 (one, two, three, four, five, six, or more) are applied on the fibers 40. It is within the scope of the present invention to apply the fiber optic cable(s) to the layers 10, 20, and/or 30 and/or on the tapes 50 and/or beneath a cover like the cover 70. Any known suitable fiber optic cables may be used, including SmartProfile (Trademark) cables from Smartec S/A Company. In one particular aspect a SmartProfile (Trademark) fiber optic cable 61 is used as shown in FIG. 10 which has a body 62, e.g. made of HDPE which encases two fiber optic cables 63, 64 in filler material 69 within a central space 65 and two additional fiber optic cables 66, 67. Either or both of the cables 63, 64 is used to measure temperature on the liner 12 and either or both of the cables 66, 67 are used to measure strain. The temperature measurements provide information regarding leaks in the liner 12 both regarding the existence of a leak and its location (temperature and strain measurements are done in prior art systems with cables on the outside of a pipe, e.g. a steel pipe). Either cable 63 or 64 may be deleted; but providing two such cables provides redundancy in the event one of them fails.

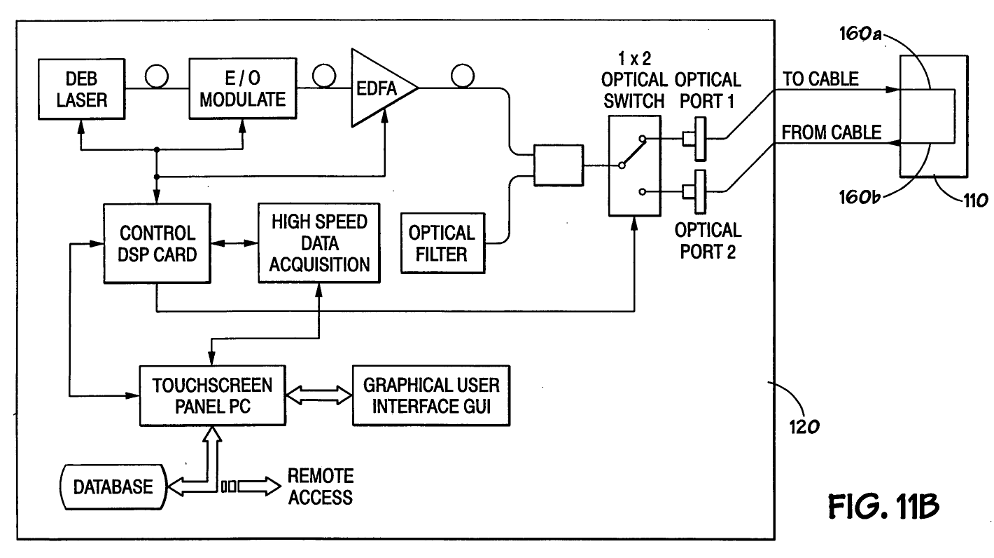

FIG. 11A shows schematically a system 100 according to the present invention for receiving, processing, and transmitting information based on the signals from fiber optic cables. A pipeline (or pipe) 110 has a liner 112 (like the liner 12 described above or like any liner according to the present invention) with a fiber optic system 114 as described above with fiber optic cables 160 (like the cables 60 described above). The pipeline 110 has a variety of pipeline-associated devices and apparatuses 104 (two shown schematically), each with an operator or controller 106. In one particular aspect, the pipeline 110 has a plurality of apparatuses 104 which are valves that selectively control the flow of fluid through the pipeline and each valve has a controller 106 which is in operational communication with the fiber optic system 114. A measurement system 120 provides a communications interface between the pipeline 110 and a control system 130 (e.g. a pipeline operator's control room with a SCADA system 136). The SCADA system 136 includes a computer system 138 which receives digitized signals from the system 120 which has converted the analog signals from the pipeline 110 into digital form) indicative of temperature and/or strain along the length of the pipeline 110. Either the system 120 or the system 138 has a programmable medium programmed to note an anomaly or spike in either temperature or strain or both. Such an anomaly or spike can indicate a potential leak (temperature spike) or a potential overstress condition or impending liner failure (strain spike) in the pipeline 110. In one aspect the system 130 activates an alarm or alarm system 140 when an alarm value for temperature, strain or both is reached. In one particular aspect, each of the apparatuses 104 is a pipeline valve; an alarm is provided by the system 140 in response to signals from the system 114 (temperature or strain or both measured and indicating a leak at a location between the valves 104), 120, 130; controllers 106 on each valve 104 are activated to close both valves 104; and both valves 104 are closed, isolating the length of the pipeline 110 between the valves.

FIG. 11B illustrates schematically one particular embodiment of a system 120 (e.g. a commercially available Model DiTest Model STA 201 from Smartec S/A company) connected to a pipeline 110. Fiber optic cables 160a, 160b are looped as shown or terminated with a reflective end (as may be done with any cable of any system herein). In one aspect, instead of looping the cable, a mirror is provided at the end of the cables 160a. 160b for beam bounce back in the same cable. As shown in FIG. 11B, the prior art measurement system 120 is, according to the present invention, used with the pipeline 110. The measurement system 120 sends a signal (e.g. a laser beam) to and through the upper (as shown in FIG. 11B) fiber optic cable 160a and receives a signal back

through the lower (as shown in FIG. 11B) fiber optic cable 160b. The system 120 inputs signals into the fiber optic cables; monitors the return signals; processes the return signals (including A/D conversion); produces digital signals indicative of measured parameters (temperature and/or strain of the pipeline 110) e.g. temperature sensitivity within 4° F. and/or strain sensitivity within 0.002%.

It is old and well-known to use grooves or recesses 71 in a cover 70 as shown in FIG. 1 (see, e.g. U.S. Pat. No. 6,220,079). Optionally, a cover 70 according to the present invention as shown in FIG. 1 may have one, two, three, four, five, six, seven, eight or more interior grooves or recesses 72. Such grooves or recesses are used within a pipeline lined with a pipe liner 12 to provide a space to hold gases from the fluid flowing through the pipeline which permeate through layers of the liner 12.

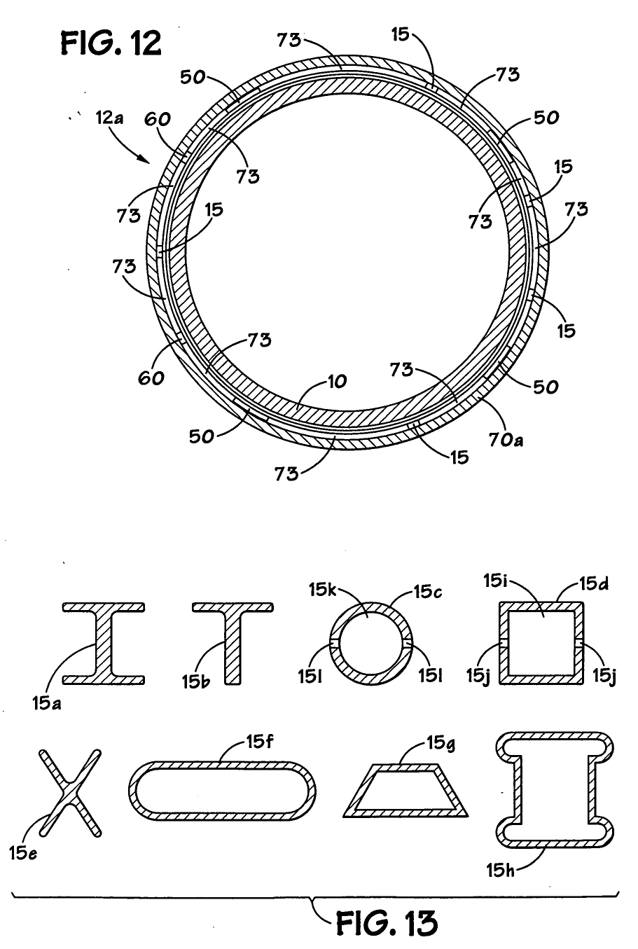

Optionally, according to the present invention, a cover 70 is provided with no grooves 71 and with no grooves 72. As shown in FIG. 12 a pipe liner 12a (like the pipe liner 12) has one, two, three, four, five, six, seven, eight or more spacers 15 (two shown) over which is applied a cover 70a. The cover 70a has no grooves, interior or exterior, and spaces 73 formed adjacent the spacers 15 provide a volume that can be entered to vent accumulated gases. Alternatively, one or more grooves like the grooves 72 and/or like the grooves 71 may be used with the liner 12a.

As shown in FIG. 13, the spacers 15 may be any desired shape (shapes 15a-15h shown in cross-section) and they may be made of any material, including, but not limited to metal, metal alloys, non-conducting metals, non-conducting metal alloys, plastic, wood, fiberglass or composite. Any hollow spacer may have a hollow interior, e.g., interiors 15i, 15k, and one or more vent holes, e.g., holes 15j or 15l.

When gases permeate a liner 10 and enter into grooves 71, grooves 72 and/or spaces 73, this accumulated gas is removed from the spaces adjacent the grooves or from the spaces 73, e.g. by vacuuming from ports provided along a pipe or pipe line. Such gas permeation is reduced, according to certain embodiments of the present invention, by co-extruding with the first layer 10 a thin layer 17 (shown partially, FIG. 1; encompasses entire length and circumference of the pipe or pipeline) of impermeable material (e.g. 0.060 inches thick) which is on the wetted side (an interior side) of the first layer 10 and serves as a pressure barrier. In one aspect this layer 17 is EVOH (ethylene vinyl alcohol copolymer) or NYLON (Trademark) material. In another aspect, to reduce gas permeation, a thin layer 19 (see FIG. 7; e.g. 0.060 inches thick) of HDPE is co-extruded with the first layer 10. The layer 19 has a plurality of functionalized single wall nano tubes throughout the layer 19 which both inhibit gas permeation through the first layer 10 and which strengthen it. In one aspect, by volume, between about 1% to 5% of a layer is made of these nano tubes; and in one particular aspect about 2%.

In certain materials and certain ballistic materials, e.g. the SPECTRA (Trademark) material creeps (i.e., elongates under loading) which can result in a loss of strength of an overall layer. To strengthen such layers and to reduce creep therein, a plurality of functionalized single wall nano tubes is added to the second layer 20 and/or to the third layer 30 (and/or to any other layer or component). Using functionalized nano tubes from NanoRidge Materials, Inc. results in substantially no increase in weight of a layer or of a component, e.g. of a layer 20 or a layer 30 due to their small size. In certain aspects, by volume these nano tubes are about 1% to 5% of a component or of a layer's total volume and, in one particular aspect, are about 2% of this total volume.

In certain aspects for the layers 10, 20, 30 a mixture of fibers can be used instead of using, e.g. only SPECTRA (Trademark) material fibers. For example, carbon fibers (20% to 50% by volume) can be mixed with SPECTRA (Trademark) fibers.

FIG. 14 illustrates a liner 12b (e.g. as a liner 12a in FIG. 12; and like numerals indicate like parts) which has been folded or deformed into the general “C” shape shown in FIG. 14. The liner 12b is folded, and the tapes 50 are positioned, so that in the folded configuration shown in FIG. 14 a plurality of tapes 50 are generally aligned with each other. With the four tapes 50 as positioned in FIG. 14, pulling of the liner 12b into a pipe or pipeline is facilitated by attaching and pulling at the location of each tape 50. It is within the scope of the present invention to provide one, two, three, four, five, six, seven, eight or more tapes like the tapes 50 aligned on a deformed liner which is deformed into any shape.

As shown in FIG. 14, according to the present invention a liner may have spacers 15 which are located so that they support the cover and/or provide channel(s) for the collection of permeated fluids. In one particular aspect as shown, the spacers 15 provide uniform support for the cover without limiting the ability to deform the liner 12.

Optionally, a connector strip or tape 14 may be used to maintain the liner 12b in its deformed shape as shown in FIG. 14. The strip or tape 14 may be glued, bonded, or adhered to the outer cover of the liner 12b at points as shown to hold the deformed liner in the configuration shown. Any suitable material may be used for the strip or tape 14; e.g., adhesive tape; duct tape; polyethylene tape; or a foil or plastic strip whose ends are glued, bonded or adhered to the liner. Such a strip or tape or strips or tapes 14 may be used with a liner deformed into any shape to maintain that shape during a liner installation procedure and/or for handling outside a pipe or pipeline prior to such installation. Upon initiation of re-forming of the liner to a full expanded configuration, the strip 14 breaks relatively easily.

FIG. 15 illustrates schematically a method according to the present invention for producing a pipe liner 12c according to the present invention which has fiber optic cables 60a (like the fiber optic cables 60 or any fiber optic cables described above) which are applied to the liner 12c as the liner 12c is being made to monitor installation effects, e.g. location in a host pipe and/or applied tension. As the liner 12c exits a liner making machine in a production system F, a system MA (e.g. like the system 120 described above) is in communication with the fiber optic cables (as the system 120 is in such communication as described above). By employing mirrors MR at the distal end of the fiber optic cables and/or by using a GPS sensor apparatus GPS (which emits a GPS locator signal transmitted through the fiber optic cables) at the end of the liner 12c, the system MA can determine the distance from the end of the liner 12c at the machine exit to the distal end of the produced liner, thereby providing a measurement of the length of the produced liner 12c. Strain, if there is any on the liner 12c as it is produced is measured providing a measure of the pulling force. Similarly, using a system MA during a liner installation procedure, a measurement is provided which indicates the length of liner installed within a pipe or pipe line; and, in one aspect, a measurement of a strain on a liner as it is pulled into a pipe or pipe line. Any pipe or pipeline herein may have a fiber optic cable or cables with a mirror MR and/or a GPS apparatus as described above.

The present invention, therefore, in certain and not necessarily all embodiments, provides a liner for pipe, the liner including: a first layer comprising a hollow cylinder of polymeric material; a second layer comprising wrap material, the wrap material wrapped around the first layer; a third layer comprising wrap material wrapped around the second layer, in one aspect the third layer at an angle to the second layer or the third layer not at an angle; the liner having a first end spaced apart from a second end and at least one strengthener member on the liner and extending from the first end to the second end of the liner; the liner being a stand-alone structure. Such a liner may have one or some, in any possible combination, of the following: wherein the polymeric material is thermoplastic material; wherein the polymeric material is thermoset material; wherein the wrap material of the second layer is oriented HMWPE fibers; wherein the wrap material of the third layer is oriented HMWPE fibers; wherein the second layer is wrapped without overlap on the first layer; wherein the third layer is wrapped without overlap on the second layer; wherein the at least one strengthener member is any of tape, sock, and flattened tube; wherein the at least one strengthener member is made of high strength fiber material; wherein the at least one strengthener member is a plurality of members spaced-apart around a circumference of the first layer; a plurality of fiber members wound around and outside of the at least one strengthener member to maintain the at least one strengthener member in position on the liner; at least one fiber optic cable extending along the liner; wherein the at least one fiber optic cable provides communication between the liner and an apparatus; a protective cover, e.g. wound on, sprayed on, or painted on and around the liner; wherein the at least one fiber optic cable is connectible for communication with a measurement system for measuring temperature; wherein the at least one fiber optic cable is connectible for communication with a measurement system for measuring strain; wherein the at least one fiber optic cable is connectible for communication with a measurement system for measuring temperature and strain; wherein the protective cover is made of polymeric material; wherein the first layer is at a first angle substantially equal to and opposite to a second angle of the second layer; wherein the second layer is bonded at discrete points or over substantially all its surface to the first layer; wherein the third layer is bonded at discrete points or over substantially all its surface to the second layer; wherein the second layer is bonded to the first layer at discrete points and the third layer is bonded to the second layer at discrete points; a plurality of standoff members disposed beneath and in contact with the cover; wherein the liner is deformable into a deformed shape for insertion into a pipe; wherein the shape is a general “C” shape; a plurality of spacer members beneath and in contact with the cover for supporting the cover without limiting deformability of the liner; and/or wherein the cover has a plurality of interior recesses for venting fluid permeating through the liner.

The present invention, therefore, in certain and not necessarily all embodiments, provides a continuous fabric reinforced stand alone pipe-liner fabricatable in-situ, the pipe liner having a longitudinal axis, and including discrete lengths of polymeric tubular extrusions welded together with welds to form a continuous cylindrical hollow member with a first end and a second end, at least two layers of reinforcement of a high-strength low-weight strengthening material, said at least two layers of reinforcement applied axially from the first end to the second end of the continuous cylindrical hollow member, wherein each of said layers has a layer width and each of said layers provides coverage of the continuous cylindrical hollow member, wherein each of said layers is wound on the continuous cylindrical hollow member at a wind angle φ, wherein the continuous cylindrical hollow member has an outside diameter, said coverage satisfying the equation
Coverage=layer width/π(Outside diameter)(Cosine φ).

Such a pipe liner may have coverage of 100% and the angle φ between 50 degrees and 60 degrees; and/or such a pipe liner may include at least one pulling members or a plurality of pulling member applied on the pipe liner from the first end to the second end, either not parallel to the longitudinal axis or substantially parallel to the longitudinal axis of the pipe liner.

The present invention, therefore, in certain and not necessarily all embodiments, provides a method for lining a pipe, the method including pulling a liner into a pipe, the liner as any disclosed herein. In certain aspects of such a method, the liner is a continuous stand-alone structure at least three, four, five or ten miles long.

The present invention, therefore, in certain and not necessarily all embodiments, provides a method for operating a controller of an apparatus on a pipeline, the method including receiving with a control system a measurement signal from a measuring system in communication with a pipeline, the pipeline having an outer pipe structure and a liner therewithin, the liner as any disclosed herein with at least one fiber optic cable extending along the liner, and a protective cover on and around the liner, and a measuring system receiving signals from the at least one fiber optic cable indicative of any of temperature within and strain on the pipeline, and controlling the controller with the control system in response to the signals.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims. Any patent or patent application mentioned herein is incorporated fully herein for all purposes.

What is claimed is:

1. A liner for pipe, the liner comprising
a first layer comprising a hollow cylinder of polymeric material,
a second layer comprising wrap material, the wrap material wrapped around the first layer,
a third layer comprising wrap material wrapped around the second layer,
the liner having a first end spaced apart from a second end,
at least one strengthener member on the liner and extending from the first end to the second end of the liner,
the liner comprising a stand-alone structure.

2. The liner of claim 1 wherein the polymeric material is thermoplastic material.

3. The liner of claim 1 wherein the polymeric material is thermoset material.

4. The liner of claim 1 wherein the wrap material of the second layer is oriented HMWPE fibers.

5. The liner of claim 1 wherein the wrap material of the third layer is oriented HMWPE fibers.

6. The liner of claim 1 wherein the second layer is wrapped without overlap on the first layer.

7. The liner of claim 1 wherein the third layer is wrapped without overlap on the second layer.

8. The liner of claim 1 wherein the at least one strengthener member is any of tape, sock, and flattened tube.

9. The liner of claim 1 wherein the at least one strengthener member is made of high strength fiber material.

10. The liner of claim 1 wherein the at least one strengthener member is a plurality of members spaced-apart around a circumference of the first layer.

11. The liner of claim 1 further comprising
a plurality of fiber members wound around and outside of the at least one strengthener member to maintain the at least one strengthener member in position on the liner.

12. The liner of claim 1 further comprising
at least one fiber optic cable extending along the liner.

13. The liner of claim 12 wherein the at least one fiber optic cable provides communication between the liner and an apparatus.

14. The liner of claim 13 further comprising
a protective cover on and around the liner.

15. The liner of claim 14 wherein the at least one fiber optic cable is connectible for communication with a measurement system for measuring temperature.

16. The liner of claim 14 wherein the at least one fiber optic cable is connectible for communication with a measurement system for measuring strain.

17. The liner of claim 14 wherein the at least one fiber optic cable is connectible for communication with a measurement system for measuring temperature and strain.

18. The liner of claim 14 wherein the protective cover is made of polymeric material.

19. The liner of claim 1 wherein the first layer is at a first angle and the second layer is at a second angle, and the first angle is substantially equal to and opposite to the second angle.

20. The liner of claim 1 wherein the second layer is bonded to the first layer.

21. The liner of claim 1 wherein the third layer is bonded to the second layer.

22. The liner of claim 1 wherein the second layer is bonded to the first layer at discrete points and the third layer is bonded to the second layer at discrete points.

23. The liner of claim 14 further comprising
a plurality of standoff members disposed beneath and in contact with the cover.

24. The liner of claim 14 wherein the liner is deformable into a deformed shape for insertion into a pipe.

25. The liner of claim 24 wherein the shape is a general “C” shape.

26. The liner of claim 26 further comprising a plurality of spacer members beneath and in contact with the cover for supporting the cover without limiting deformability of the liner.

27. The liner of claim 14 wherein the cover has a plurality of interior recesses for venting fluid permeating through the liner.

28. A continuous fabric reinforced stand alone pipe-liner fabricatable in-situ, the pipe liner having a longitudinal axis, and including
discrete lengths of polymeric tubular extrusions welded together with welds to form a continuous cylindrical hollow member with a first end and a second end,
at least two layers of reinforcement of a high-strength low-weight strengthening material, said at least two layers of reinforcement applied axially from the first end to the second end of the continuous cylindrical hollow member, wherein each of said layers of reinforcement has a layer width and each of said layers of reinforcement provides coverage of the continuous cylindrical hollow member, wherein each of said layers of reinforcement is wound on the continuous cylindrical hollow member at a wind angle φ, wherein the continuous cylindrical hollow member has an outside diameter, said coverage satisfying the equation
Coverage=layer width/π(Outside diameter)(Cosine φ).

29. The pipe liner of claim 28 wherein the coverage is 100% and the angle φ is between 50 degrees and 60 degrees.

30. The pipe liner of claim 28 further comprising
at least one pulling member applied on the pipe liner from the first end to the second end substantially parallel to the longitudinal axis of the pipe liner.

31. A method for lining a pipe, the method comprising
pulling a liner into a pipe, the liner comprising a first layer comprising a hollow cylinder of polymeric material, a second layer comprising wrap material, the wrap material wrapped around the first layer, a third layer comprising wrap material wrapped around the second layer, the third layer at an angle to the second layer, the liner having a first end spaced apart from a second end, at least one strengthener member on the liner and extending from the first end to the second end of the liner, the liner comprising a stand-alone structure, and a protective cover on and around the liner.

32. The method of claim 31 wherein the liner is a continuous stand-alone structure at least ten miles long.

33. A method for operating a controller of an apparatus on a pipeline, the method comprising
receiving with a control system a measurement signal from a measuring system in communication with a pipeline, the pipeline having an outer pipe structure and a liner therewithin, the liner comprising a first layer comprising a hollow cylinder of polymeric material, a second layer comprising wrap material, the wrap material wrapped around the first layer, a third layer comprising wrap material wrapped around the second layer, the third layer at an angle to the second layer, the liner having a first end spaced apart from a second end, at least one strengthener member on the liner and extending from the first end to the second end of the liner, the liner comprising a stand-alone structure, at least one fiber optic cable extending along the liner, and a protective cover on and around the liner, the measuring system receiving signals from the at least one fiber optic cable indicative of any of temperature within and strain on the pipeline,
controlling the controller with the control system in response to the measurement signal.
